(19) United States
(12) Patent Application Publication
(10) Pub. No.: US 2009/0223010 A1
(43) Pub. Date: Sep. 10, 2009

(54) Windshield wiper system

(76) Inventor: Sean Z. Richey, Tampa, FL (US)

Correspondence Address: EDWARD P. DUTKIEWICZ, P.A.;EDWARD P. DUTKIEWICZ, P.O. Box 937, Dade City, FL, 33526, US

(21) Appl. No.: 12/075,165

(22) Filed: Mar. 10, 2008

(51) Int. Cl. B60S 1/04

(52) U.S. Cl. 15/250.32

(57) ABSTRACT

A windshield wiper arm mount has a cross bar. An arm mount lock locks the cross bar to a wiper arm. A mount block is provided. A pair of similarly configured backing strips are coupled to a strengthening rib, a coupling component, a first wiper component, and a second wiper component. The first wiper component is a rubber strip to wipe the windshield and the second wiper component has an abrasive quality to help clean debris from the windshield. A pair of end caps hold the components together.

### RULE 1.78(F)(1) DISCLOSURE

The Applicant has not submitted a related pending or patented non-provisional application within two months of the filing date of this present application. The invention is made by a single inventor, so there are no other inventors to be disclosed. This application is not under assignment to any other person or entity at this time.

### BACKGROUND OF THE INVENTION

1. Field of the Invention

The present invention relates to a windshield wiper system and more particularly pertains to a new configuration of a windshield wiper system having a wiping blade and a scrubbing blade.

2. Description of the Prior Art

The use of other wiper blade configurations is known in the prior art. More specifically, other wiper blade configurations previously devised and utilized for the purpose of cleaning a windshield are known to consist basically of familiar, expected, and obvious structural configurations, notwithstanding the myriad of designs encompassed by the crowded prior art which has been developed for the fulfillment of countless objectives and requirements.

By way of example, U.S. Pat. No. 6,495,815 issued to Stam et al on Dec. 17, 2002, discloses a moisture sensor and windshield fog detector. U.S. Pat. No. 5,406,672 issued to Hipke on Apr. 18, 1995 discloses a windshield wiper system including wiping and scrubbing blades. Lastly, U.S. Pat. No. 4,745,653 issued to Bliznak on May 24, 1988 discloses a wiper/scraper/washer blade for windows on transportation means.

While these devices fulfill their respective, particular objectives and requirements, the aforementioned patents do not describe windshield wiper system that is herein described and having a new configuration.

In this respect, the windshield wiper system according to the present invention substantially departs from the conventional concepts and designs of the prior art, and in doing so provides an apparatus primarily developed for the purpose of a new configuration of a windshield wiper system.

Therefore, it can be appreciated that there exists a continuing need for a new and improved windshield wiper system. In this regard, the present invention substantially fulfills this need.

### SUMMARY OF THE INVENTION

In view of the foregoing disadvantages inherent in the known types of other wiper blade configurations now present in the prior art, the present invention provides an improved windshield wiper system. As such, the general purpose of the present invention, which will be described subsequently in greater detail, is to provide a new and improved windshield wiper system which has all the advantages of the prior art and none of the disadvantages.

To attain this, the present invention essentially comprises a windshield wiper system comprising several components, in combination.

A windshield wiper arm is coupled to a windshield wiper motor. The arm has a motor end and a wiper end.

Next provided is an arm mount. The arm mount has a lower C-shaped component having a downwardly disposed opening and an upper C-shaped component having a upwardly disposed opening. The upper component has a mounting cross bar and a pair of indexing apertures. The mounting cross bar is configured to be mated with and received by the wiper end of the windshield wiper arm.

Next provided is an arm mount lock. The arm mount lock has a generally C-shaped configuration. The mount lock has two opposed side portions and a top portion. The top portion has a notch therein. The side portions each have opposing notches cut therein. The side notches are each configured to mate with and receive the cross bar of the upper component when the windshield wiper arm and arm mount are coupled together. The mount lock thereby locks the wiper arm and arm mount together.

Next provided is a mount block. The mount block is fabricated of a rigid material and has a generally I-shaped configuration. The mount block has a first length, a width, a height, a top, a concave bottom, a pair of sides, and a pair of ends. The mount block comprises a base plate and a top plate with a vertical connector there between. The vertical connector, the base plate, and the top plate form a pair of lateral grooves along the length of the block on both sides of the block. The top plate of the mount block has a generally rectilinear configuration. The top plate is sized to mate with and be received by the downwardly disposed opening of the arm mount. The base plate of the mount block has a plurality of fastener apertures therein.

Next provided is a pair of similarly configured backing strips. The backing strips are each fabricated of a rigid material. Each of the backing strips have an upper surface and a lower surface with a thickness there between. Each of the backing strips have two ends and a second length.

Each upper surface of the backing strips is configured in a generally pointed shape comprising the intersecting to two mirror image configured concave surfaces. Each concave surface has an intersecting upper edge and a generally J-shaped lower edge. The J-shaped lower edges of the concave surfaces form a track there between.

Next provided is a strengthening rib. The strengthening rib is fabricated of a rigid material and has a generally rectilinear configuration. The strengthening rib has an upper surface and a lower surface with a thickness there between thereby forming a lateral edge around the periphery of the rectilinear configuration. The lateral edge has two opposing side edges and two opposing end edges. The rib has a third length. The rib has a slot between the upper and lower surfaces running along the length of the rib from a location adjacent to an end edge to the a location adjacent at the opposing end edge. The slot has an enlarged slot area at both ends of the slot. The rib has a plurality of fastening apertures there through, with the fastening apertures of the rib being configured to mate with the fastener apertures of the mount block.

Next provided is a plurality of fasteners to couple the rib and the mount block together.

Next provided is a coupling component. The coupling component is fabricated of a rigid material and has an upper portion and a lower portion. The upper portion of the coupling component has a generally T-shaped configuration of a fourth length. The fourth length is less than the third length. The upper portion has a horizontal upper end and a vertical lower end having a groove.

The lower portion of the coupling component comprises a pair of like-configured parallel, generally C-shaped, receiving surfaces of a third length. The upper surface of the lower portion has a groove that mates with, and continues with, the groove of the lower end of the upper portion.

Next provided is a first wiper component. The first wiper component is fabricated of a resilient material and has a T-shaped upper portion. The first wiper component is configured to be received by, and mated with, a first of the C-shaped receiving surfaces of the coupling component. The first wiper component also comprises a wiping portion configured to mate with a recipient windshield surface.

Next provided is a second wiper component. The second wiper component is fabricated of a resilient material, and has a T-shaped upper portion. The second wiper component is configured to be received by, and mated with, a second of the C-shaped receiving surfaces of the coupling component. The second wiper component also comprises a wiping portion having a soft core and a generally coarse surface which is configured to mate with the recipient windshield surface.

Lastly provided is a pair of end caps. Each of the end caps is fabricated of a rigid material. Each of the end caps is configured with a closed end and an open end. The open end is configured to mate with, and be received by, the backing strip, the rib, and the lower coupling component, so as to couple the backing strip, the rib, and the lower coupling component together.

There has thus been outlined, rather broadly, the more important features of the invention in order that the detailed description thereof that follows may be better understood and in order that the present contribution to the art may be better appreciated. There are, of course, additional features of the invention that will be described hereinafter and which will form the subject matter of the claims attached.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved windshield wiper system which has all of the advantages of the prior art wiper blade configurations and none of the disadvantages.

It is another object of the present invention to provide a new and improved windshield wiper system which may be easily and efficiently manufactured and marketed.

It is further object of the present invention to provide a new and improved windshield wiper system which is of durable and reliable constructions.

An even further object of the present invention is to provide a new and improved windshield wiper system which is susceptible of a low cost of manufacture with regard to both materials and labor, and which accordingly is then susceptible of low prices of sale to the consuming public, thereby making such windshield wiper system economically available to the buying public.

Even still another object of the present invention is to provide a windshield wiper system for a new configuration.

Lastly, it is an object of the present invention to provide a new and improved windshield wiper system comprises several components, in combination. A windshield wiper arm mount has a cross bar. An arm mount lock locks the cross bar to a wiper arm. A mount block is provided. A pair of similarly configured backing strips are coupled to a strengthening rib, a coupling component, a first wiper component, and a second wiper component. The first wiper component is a rubber strip to wipe the windshield and the second wiper component has an abrasive quality to help clean debris from the windshield. A pair of end caps hold the components together.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is side elevation of the wiper system installed on a wiper arm of an existing motor vehicle.

FIG. 2 is a perspective view of the wiper system showing the system not attached to a motor vehicle.

FIG. 3 is a elevational view taken along line 3-3 of FIG. 2.

FIG. 4 is a side elevational view from the same orientation as is FIG. 3, the view being of another embodiment of the system. Note the multiple rubber wiping blades.

FIG. 5 is a cut away view of an end of the system, with end cap removed, demonstrating the orientation of the parts of the system.

FIG. 6 is a cross sectional view taken along line 6-6 of FIG. 5.

FIG. 7 is a cross sectional view taken along line 7-7 of FIG. 2.

FIG. 8 is an exploded view of the system, showing the parts and the relationships thereof.

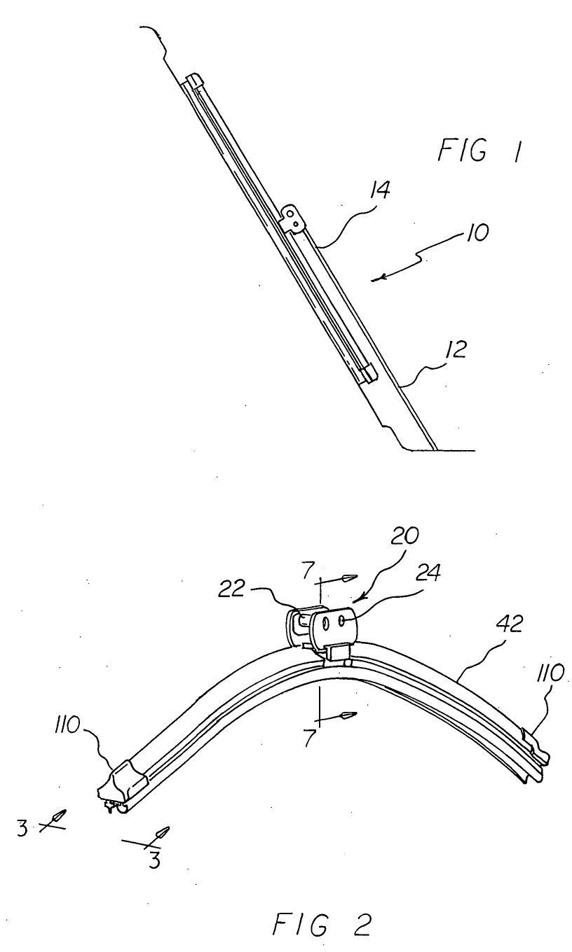

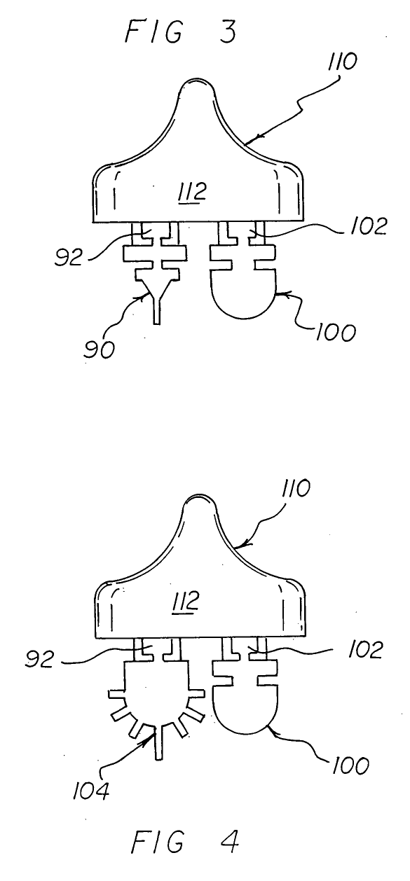

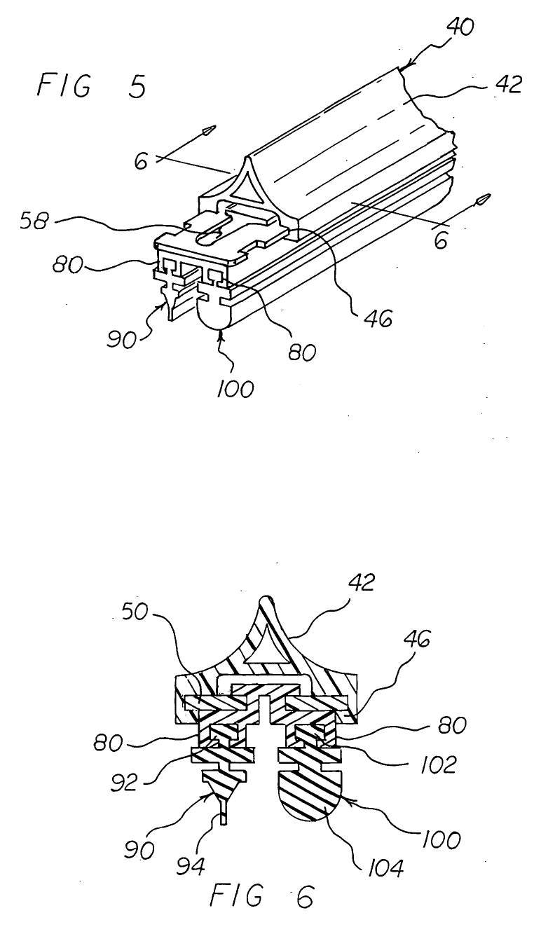

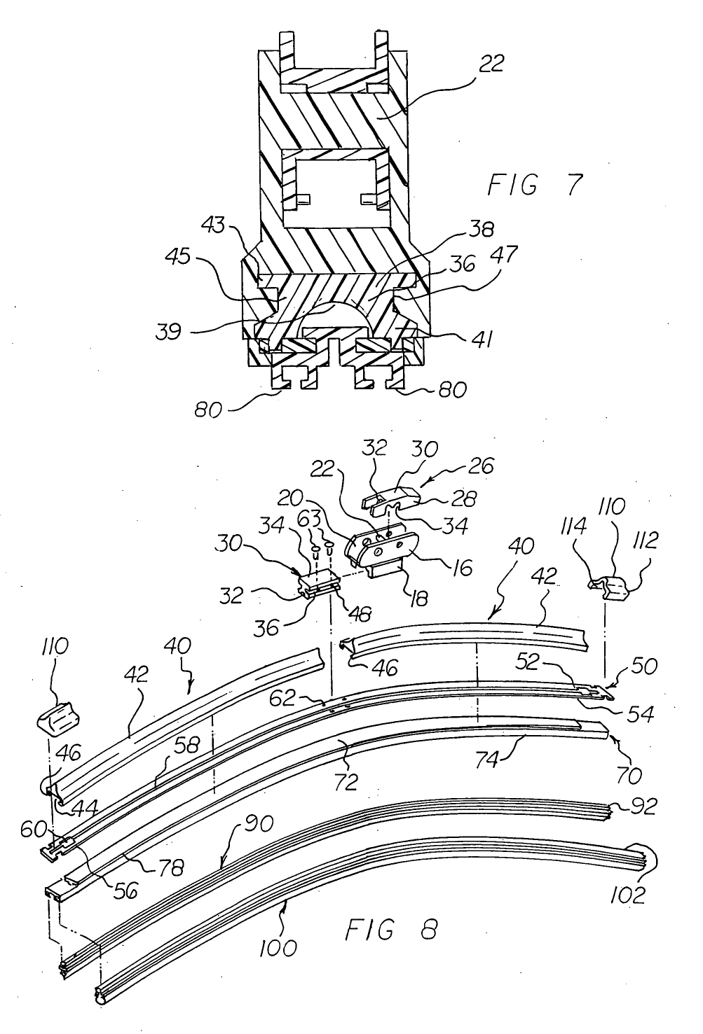

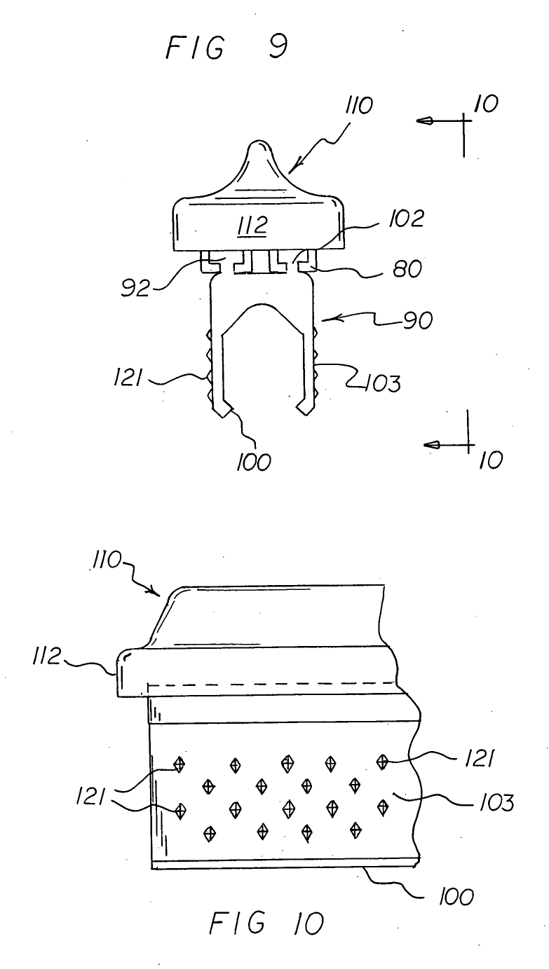

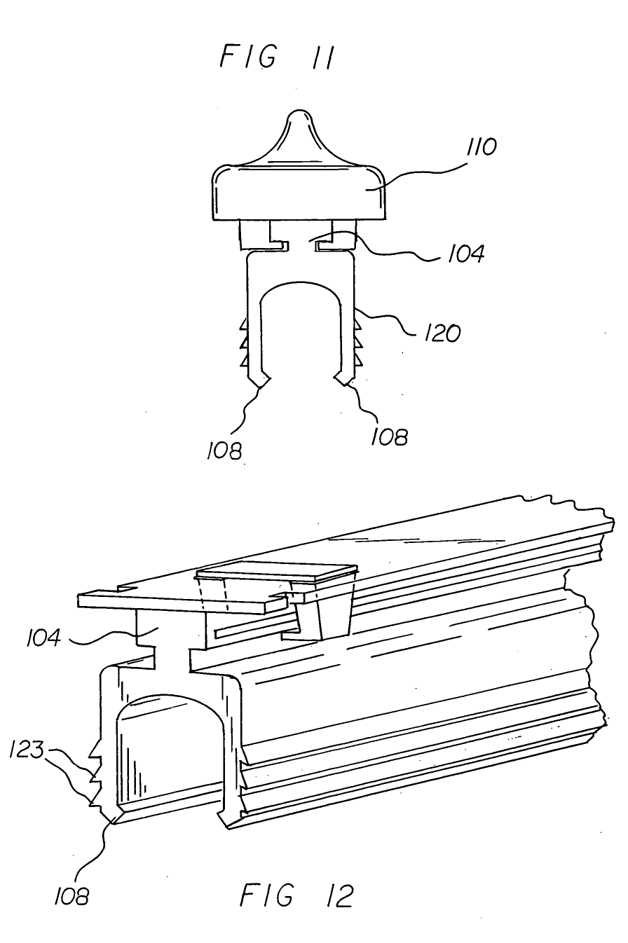

The same reference numerals refer to the same parts throughout the various Figures.

### DESCRIPTION OF THE PREFERRED EMBODIMENT

With reference now to the drawings, and in particular to FIG. 1 thereof, the preferred embodiment of the new and improved windshield wiper system embodying the principles and concepts of the present invention and generally designated by the reference numeral 10 will be described.

The present invention, the windshield wiper system 10 is comprised of a plurality of components. Such components in their broadest context include an arm mount, an arm mount lock, a pair of backing strips, a metal rib and a plurality of wiper blades. Such components are individually configured and correlated with respect to each other so as to attain the desired objective.

A windshield wiper arm 12 is coupled to a windshield wiper motor (not shown) as is common in the industry. The arm has a motor end and a wiper end 14. The motor end of the arm couples to the windshield motor shaft.

Next provided is an arm mount 16. The arm mount has a lower C-shaped component 18 having a downwardly disposed opening and an upper C-shaped component 20 having a upwardly disposed opening. The upper component has a mounting cross bar and a pair of indexing apertures. The mounting cross bar 22 is configured to be mated with and received by the wiper end of the windshield wiper arm. The cross bar is commonly available and widely used in the industry.

Other embodiments of a means to secure the wiper arm to the arm mount may be a ball and socket arrangement, a slip fastener or clip, or a pin.

Next provided is an arm mount lock 26. The arm mount lock has a generally C-shaped configuration. The mount lock has two opposed side portions 28 and a top portion 30. The top portion has a notch 32 therein. The side portions each have opposing notches 34 cut therein. The side notches are each configured to mate with and receive the cross bar of the upper component when the windshield wiper arm and arm mount are coupled together. The mount lock thereby locks the wiper arm and arm mount together. The arm mount lock is configured to slidably engage the arm mount. The notching allows the system to pivot and move about the cross bar, allowing for the contour of the windshield as the motor moves the system across the windshield, back and forth.

Next provided is a mount block 30. The mount block is fabricated of a rigid material and has a generally I-shaped configuration. The mount block has a first length, a width, a height, a top, a concave bottom, a pair of sides, and a pair of ends. The mount block comprises a base plate 32 and a top plate 34 with a vertical connector there between. The vertical connector, the base plate, and the top plate form a pair of lateral grooves 36 along the length of the block on both sides of the block. The top plate of the mount block has a generally rectilinear configuration. The top plate is sized to mate with and be received by the downwardly disposed opening of the arm mount. The base plate of the mount block has a plurality of fastener apertures therein. The mount block provides a solid anchoring point for the arm mount and rib of the system. This provides stability and strength to the system.

Next provided is a pair of similarly configured backing strips 40. The backing strips are each fabricated of a rigid material. Each of the backing strips have an upper surface 42 and a lower surface 44 with a thickness there between. Each of the backing strips have two ends and a second length.

Each upper surface of the backing strips is configured in a generally pointed shape comprising the intersecting to two mirror image configured concave surfaces. Each concave surface has an intersecting upper edge and a generally J-shaped lower edge 46. The J-shaped lower edges of the concave surfaces form a track 48 there between.

Next provided is a strengthening rib 50. The strengthening rib is fabricated of a rigid material and has a generally rectilinear configuration. The strengthening rib has an upper surface 52 and a lower surface 54 with a thickness there between thereby forming a lateral edge 56 around the periphery of the rectilinear configuration.

The lateral edge has two opposing side edges and two opposing end edges. The rib has a third length. The rib has a slot 58 between the upper and lower surfaces running along the length of the rib from a location adjacent to an end edge to the a location adjacent at the opposing end edge. The slot has an enlarged slot area 60 at both ends of the slot. The rib has a plurality of fastening apertures 62 there through, with the fastening apertures of the rib being configured to mate with the fastener apertures of the mount block.

The slot may have various configurations. The preferred embodiment is described above, but the slot may have more than two enlarged areas, or none at all. In other embodiments the rib may be fabricated without any fastening apertures therein.

Next provided is a plurality of fasteners (not shown) to couple the rib and the mount block together. In the preferred embodiment the fasteners are rivets, one skilled in the art would recognize that any type of fastener could be used. Such fasteners include screws, clips, wires, pins, adhesives and weldments.

Next provided is a coupling component 70. The coupling component is fabricated of a rigid material and has an upper portion 72 and a lower portion 74. The upper portion of the coupling component has a generally T-shaped configuration of a fourth length. The fourth length is less than the third length. The upper portion has a horizontal upper end and a vertical lower end having a groove 78.

The lower portion of the coupling component comprises a pair of like-configured parallel, generally C-shaped, receiving surfaces 80 of a third length. The upper surface of the lower portion has a groove that mates with, and continues with, the groove of the lower end of the upper portion.

Next provided is a first wiper component 90. The first wiper component is fabricated of a resilient material and has a T-shaped upper portion 92. The first wiper component is configured to be received by, and mated with, a first of the C-shaped receiving surfaces of the coupling component. The first wiper component also comprises a wiping portion 94 configured to mate with a recipient windshield surface.

Next provided is a second wiper component 100. The second wiper component is fabricated of a resilient material, and has a T-shaped upper portion 102. The second wiper component is configured to be received by, and mated with, a second of the C-shaped receiving surfaces of the coupling component. The second wiper component also comprises a wiping portion 104 having a soft core and a generally coarse surface which is configured to mate with the recipient windshield surface.

In other embodiments, the T-shaped upper portions of the first and second wiper components may be shaped differently, so as to allow easy coupling with the coupling component. In these embodiments, the upper portions may be clamped, clipped, or adhered to the coupling component.

In other embodiments the rubber wiper blade, or first blade, may have a plurality of wiping edges 104 thereon.

Lastly provided is a pair of end caps 110. Each of the end caps is fabricated of a rigid material. Each of the end caps is configured with a closed end 112 and an open end 114. The open end is configured to mate with, and be received by, the backing strip, the rib, and the lower coupling component, so as to couple the backing strip, the rib, and the lower coupling component together.

As to the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed as being new and desired to be protected by Letters Patent of the United States is as follows:

1. A windshield wiper system comprising, in combination:
a windshield wiper arm mount having a cross bar;
a mount lock;
a mount block;
a pair of similarly configured backing strips;
a strengthening rib;
a coupling component fabricated of a rigid material having an upper portion and a lower portion;
a first wiper component comprising a wiping portion configured to mate with a recipient windshield surface;
a second wiper component comprising a wiping portion having a soft core and a generally coarse surface configured to mate with the recipient windshield surface; and
a pair of end caps, each end cap being fabricated of a rigid material and each end cap being configured with a closed end and an open end.

2. A windshield wiper system as described in claim 1 with windshield arm mount having a lower C-shaped component having a downwardly disposed opening and an upper C-shaped component having a upwardly disposed opening.

3. A windshield wiper system as described in claim 2 with the upper component having a pair of indexing apertures, the mounting cross bar being configured to be mated with and received by a wiper end of a windshield wiper arm.

4. A windshield wiper system as described in claim 1 with the arm mount lock having a generally C-shaped configuration.

5. A windshield wiper system as described in claim 4 with the system further comprising the mount lock having two opposed side portions and a top portion.

6. A windshield wiper system as described in claim 5 with the top portion having a notch therein and the side portions each having opposing side notches cut therein, the side notches being configured to mate with and receive the cross bar of the upper component when the windshield wiper arm and arm mount are coupled together, the mount lock thereby locking the wiper arm and arm mount together.

7. A windshield wiper system as described in claim 1 with the mount block being fabricated of a rigid material having a generally I-shaped configuration having a first length and a width and a height and a top and a concave bottom and a pair of sides and a pair of ends.

8. A windshield wiper system as described in claim 7 with the mount block further comprising a base plate and a top plate and a vertical connector, the vertical connector and base plate and top plate forming a pair of lateral grooves along the length of the block on both sides of the block, with the top plate of the mount block having a generally rectilinear configuration and sized to mate with and be received by the downwardly disposed opening of the arm mount.

9. A windshield wiper system as described in claim 8 wherein the top portion the base plate of the mount block has a plurality of fastener apertures therein.

10. A windshield wiper system as described in claim 1 wherein the backing strips are each fabricated of a rigid material with each having an upper surface and a lower surface with a thickness there between and two ends and a second length.

11. A windshield wiper system as described in claim 10 with each upper surface of the backing strips being configured in a generally pointed shape comprising the intersecting to two mirror image configured concave surfaces with each concave surface having an intersecting upper edge and a generally J-shaped lower edge, with the J-shaped lower edges of the concave surfaces forming a track there between.

12. A windshield wiper system as described in claim 1 wherein the strengthening rib is fabricated of a rigid material having a generally rectilinear configuration with an upper surface and a lower surface and a thickness there between forming a lateral edge around the periphery of the rectilinear configuration, the lateral edge having two opposing side edges and two opposing end edges.

13. A windshield wiper system as described in claim 12 wherein the rib has a third length with the rib having a slot between the upper and lower surfaces running along the length of the rib from a location adjacent to an end edge to the a location adjacent at the opposing end edge.

14. A windshield wiper system as described in claim 13 wherein the rib further comprises the slot having an enlarged slot area at both ends of the slot, the rib having a plurality of fastening apertures there through with the fastening apertures of the rib being configured to mate with the fastener apertures of the mount block.

15. A windshield wiper system as described in claim 1 wherein the system further comprises a plurality of fasteners to couple the rib and the mount block together.

16. A windshield wiper system as described in claim 1 with the coupling component of the upper portion having a generally T-shaped configuration of a fourth length, the fourth length being less than the third length, the upper portion having a horizontal upper end and a vertical lower end having a groove.

17. A windshield wiper system as described in claim 1 wherein the lower portion of the coupling component comprises a pair of like-configured parallel generally C-shaped receiving surfaces of a third length.

18. A windshield wiper system as described in claim 1 wherein the first wiper component is fabricated of a resilient material having a T-shaped upper portion configured to be received by and mate the coupling component.

19. A windshield wiper system as described in claim 1 wherein the second wiper component is fabricated of a resilient material, the second wiper component having a T-shaped upper portion configured to be received by and mate with the coupling component.

20. A windshield wiper system as described in claim 1 with the open end of the end cap being configured to mate with and receive the backing strip and the rib and the lower coupling component so as to couple the backing strip and the rib and the lower coupling component together.

21. A windshield wiper system comprising, in combination:
a windshield wiper arm being coupled to a windshield wiper motor, the arm having a motor end and a wiper end;
an arm mount having a lower C-shaped component having a downwardly disposed opening and an upper C-shaped component having a upwardly disposed opening, the upper component having a mounting cross bar and a pair of indexing apertures, the mounting cross bar being configured to be mated with and received by the wiper end of the windshield wiper arm;
an arm mount lock having a generally C-shaped configuration with the mount lock having two opposed side portions and a top portion, the top portion having a notch therein and the side portions each having opposing notches cut therein, the side notches being configured to mate with and receive the cross bar of the upper component when the windshield wiper arm and arm mount are coupled together, the mount lock thereby locking the wiper arm and arm mount together;
a mount block fabricated of a rigid material having a generally I-shaped configuration having a first length and a width and a height and a top and a concave bottom and a pair of sides and a pair of ends, the mount block comprising a base plate and a top plate and a vertical connector, the vertical connector and base plate and top plate forming a pair of lateral grooves along the length of the block on both sides of the block, with the top plate of the mount block having a generally rectilinear configuration and sized to mate with and be received by the downwardly disposed opening of the arm mount, the base plate of the mount block having a plurality of fastener apertures therein;
a pair of similarly configured backing strips, the backing strips each being fabricated of a rigid material with each having an upper surface and a lower surface with a thickness there between and two ends and a second length, each upper surface of the backing strips being configured in a generally pointed shape comprising the intersecting to two mirror image configured concave surfaces with each concave surface having an intersecting upper edge and a generally J-shaped lower edge, with the J-shaped lower edges of the concave surfaces forming a track there between;
a strengthening rib fabricated of a rigid material having a generally rectilinear configuration with an upper surface and a lower surface and a thickness there between forming a lateral edge around the periphery of the rectilinear configuration, the lateral edge having two opposing side edges and two opposing end edges, the rib having a third length with the rib having a slot between the upper and lower surfaces running along the length of the rib from a location adjacent to an end edge to the a location adjacent at the opposing end edge, the slot having an enlarged slot area at both ends of the slot, the rib having a plurality of fastening apertures there through with the fastening apertures of the rib being configured to mate with the fastener apertures of the mount block;
a plurality of fasteners to couple the rib and the mount block together;
a coupling component fabricated of a rigid material having an upper portion and a lower portion, the upper portion having a generally T-shaped configuration of a fourth length, the fourth length being less than the third length, the upper portion having a horizontal upper end and a vertical lower end having a groove, the lower portion of the coupling component comprising a pair of like configured parallel generally C-shaped receiving surfaces of a third length, the upper surface of the lower portion having a groove that mates with and continues with the groove of the lower end of the upper portion;
a first wiper component fabricated of a resilient material having a T-shaped upper portion configured to be received by and mate with a first of the C-shaped receiving surfaces of the coupling component, the first wiper component also comprising a wiping portion configured to mate with a recipient windshield surface;
a second wiper component fabricated of a resilient material, the second wiper component having a T-shaped upper portion configured to be received by and mate with a second of the C-shaped receiving surfaces of the coupling component, the second wiper component also comprising a wiping portion having a soft core and a generally coarse surface configured to mate with the recipient windshield surface; and
a pair of end caps, each end cap being fabricated of a rigid material and each end cap being configured with a closed end and an open end, the open end being configured to mate with and receive the backing strip and the rib and the lower coupling component so as to couple the backing strip and the rib and the lower coupling component together.
